(19) United States
(12) Patent Application Publication
(10) Pub. No.: US 2015/0205694 A1
(43) Pub. Date: Jul. 23, 2015

(54) SYSTEM AND METHOD FOR REMOTELY CHECKING DEVICE STATUS

(71) Applicant: Asher Dahan, Los Angeles, CA (US)

(72) Inventor: Asher Dahan, Los Angeles, CA (US)

(21) Appl. No.: 14/603,226

(22) Filed: Jan. 22, 2015

Related U.S. Application Data
(60) Provisional application No. 61/930,148, filed on Jan. 22, 2014.

(51) Int. Cl. G06F 11/32; G06F 11/30

(52) U.S. Cl. CPC G06F 11/324; G06F 11/3051

(57) ABSTRACT

A system and method for remotely checking device status. The system and method may comprise a target device; and a mobile electronic device; wherein the target device comprises a lock and a transceiver; wherein the transceiver is configured to generate one or more signals about the lock; wherein the mobile electronic device comprises one or more indicators; wherein the mobile electronic device is configured to detect the one or more signals; and wherein the one or more signals trigger the one or more indicators to provide a status of the lock.

### CROSS-REFERENCE TO RELATED APPLICATIONS

This Application takes priority from U.S. Provisional Patent Application No. 61/930,148, filed on Jan. 22, 2014, titled “System of Method For Remotely Checking Device Status”, by inventor Asher Dahan, the contents of which are expressly incorporated herein by this reference as though set forth in their entirety, and to which priority is claimed.

### DETAILED DESCRIPTION

In the following detailed description of various embodiments, numerous specific details are set forth in order to provide a thorough understanding of various aspects of one or more embodiments. However, one or more embodiments may be practiced without some or all of these specific details. In other instances, well-known methods, procedures, and/or components have not been described in detail so as not to unnecessarily obscure aspects of the embodiments.

While multiple embodiments are disclosed, still other embodiments of the present disclosure will become apparent to those skilled in the art from the following detailed description, which shows and describes illustrative embodiments. As will be realized, the embodiments are capable of modifications in various obvious aspects, all without departing from the spirit and scope of the present disclosure. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In essence, the innovation comprises a system that remotely reports (a) whether a device is locked or unlocked, or (b) whether the last signal recorded was to lock or to unlock the device (referred to herein as the ‘target device’). The target device will include (but not excluding other options) for example: cars, garage door opener, door locks for houses, containers, storage units, airplanes, boats and yachts, motorcycles, warehouses, and other “property” that is protected by electronic lock.

One embodiment of the invention may involve a physical receiver/transmitter mechanism placed or implanted in or near the target device. Or, such a mechanism may be placed or implanted in or near the remote key or in or near a smart phone or other mobile electronic device (“MED”). This MED may include for example smart watch, smart phone, smart glasses, smart ring, smart bracelet, embedded display in body, built into key display and any other form of electronic display.

In these embodiments, the mechanism detects a signal and records it as either a ‘go to lock’ command or ‘go to unlock’ command from a remote key device or as either an ‘okay, I am locked’ or ‘okay, I am unlocked’ transmission from the target device. The mechanism then transmits a status of ‘locked’ or ‘unlocked’ to the user's MED. The MED is configured to receive a signal from the mechanism that indicates whether the target device is locked or unlocked and then to display a status of ‘device locked’ or ‘device unlocked’ continuously or when queried by the user. In addition the MED will record information regarding time and date that it recorded ‘locked’ or ‘unlocked’ condition.

In another embodiment, the system involves no additional mechanism at all, just a MED that employs the input channels already included in many smart phones, or the like. The MED detects the signal and records it as either a ‘go to lock’ command or ‘go to unlock’ command from a remote key device or as either an ‘okay, I am locked’ or ‘okay, I am unlocked’ transmission from the device. Then, the MED display a status of ‘device locked’ or ‘device unlocked’ continuously or when queried by the user.

In yet another embodiment of the invention, the system does not require remote key since many remote key system are being replaced by biometric authentication technology. In such a system, the signal detected would more likely be transmitted directly from the target device itself.

And, yet another embodiment, the ‘okay, I am locked’ and ‘Okay, I am unlocked’ signal could simply be the audible sounds created by the target device, whether this is a beep or even the mechanical clicks the device makes when locking or unlocking, or a Bluetooth signal, or an NFC signal, or a light signal—in which case the system may require a ‘learn’ mode for what the particular status sound like for the particular target device.

And, more broadly speaking, yet another embodiment of this invention encompasses the status of any other typically-binary device feature: on or off, open or closed, up or down, moving or stopped, etc. In each instance, the like the ‘locked’ or ‘unlocked’ status report, the MED can display a continuous basis or only upon request this particular status of the target device.

The invention can be used in variety of different applications. I can see it being used by all car manufacturers, garage door opener manufacturers, door locks for houses manufacturers, container manufacturers, storage units, airplanes manufacturers, boats and yachts manufacturers, motorcycles manufacturer's warehouses, and other “property” that is protected by electronic lock.

The invention will allow an owner to get the status (locked or unlocked) of a “target” device as listed above, and save the aggravation of not knowing, or wasting the time to return and check the status.

The invention can be used as an add-on separate product, or built directly into an existing target device. (such as car, boat or garage door opener).

The invention can be used by any person who owns a car with electronic lock system, a house owner with garage door, and all other examples that are listed above.

The invention will be sold to be used as a patented invention to manufacturers of cars, boats, garage openers, and many others examples listed above.

Included are drawings showing examples of how I can make the invention. This is only one example of an add on device. Other options will be developed.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. A system for remotely checking a device status, comprising:
a target device; and
a mobile electronic device;
wherein said target device comprises a lock and a transceiver;
wherein said transceiver is configured to generate one or more signals about said lock;
wherein said mobile electronic device comprises one or more indicators;
wherein said mobile electronic device is configured to detect said one or more signals; and
wherein said one or more signals trigger said one or more indicators to provide a status of said lock.

2. The system according to claim 1, wherein said one or more signals are one or more status signals.

3. The system according to claim 1, wherein said one or more signals are one or more command signals.

4. A method for remotely checking a device status, the steps comprising:
providing a target device and a mobile electronic device;
wherein said target device comprises a lock and a transceiver;
generating one or more signals about said lock by said transceiver;
wherein said mobile electronic device comprises one or more indicators;
detecting said one or more signals by said mobile electronic device; and
triggering said one or more indicators by said one or more signals to provide a status of said lock.

5. The system according to claim 1, wherein said one or more signals are one or more status signals.

6. The system according to claim 1, wherein said one or more signals are one or more command signals.
